(19) United States
(12) Patent Application Publication
(10) Pub. No.: US 2025/0227130 A1
(43) Pub. Date: Jul. 10, 2025

(54) INFORMATION PROCESSING APPARATUS, NETWORK SETTING METHOD, AND STORAGE MEDIUM

(71) Applicant: CANON KABUSHIKI KAISHA, Tokyo (JP)

(72) Inventor: HARUKI SATO, Kanagawa (JP)

(21) Appl. No.: 18/987,042

(22) Filed: Dec. 19, 2024

(30) Foreign Application Priority Data
Jan. 5, 2024 (JP) 2024-000806

(51) Int. Cl. H04L 9/40

(52) U.S. Cl. CPC H04L 63/205

(57) ABSTRACT

A server-configurable information processing apparatus performs a setting whether server functions are enabled or disabled, performs a setting whether or not to connect the information processing apparatus to a serverless computing environment, and gives notification prompting a user to change a setting so as to restrict use of the server functions in the serverless computing environment when the server functions are set to be enabled and the information processing apparatus is set to be connected to the serverless computing environment.

### BACKGROUND OF THE INVENTION

### Field of the Invention

The present invention relates to an information processing apparatus, a network setting method, and a storage medium.

### Description of the Related Art

In recent years, in offices, there is progress in a movement (cloud shift) of replacing a business system such as a storage, a mail server, and an application prepared on a known internal network with a cloud service. Due to the cloud shift, companies that realize all business systems by cloud services have emerged.

When all business systems in a company are in a cloud service, employees of the company can perform business by each information device connected to the internal network only having to communicate with various cloud services as a client. Therefore, each information device is not required to have server functions. Such a network environment is hereinafter called a “serverless computing environment”.

Information devices connected to a network have a risk of being attacked via the network. As a countermeasure against an attack from a network, a method of reducing the risk of attack by limiting available server functions to the minimum necessary is common. For example, Japanese Patent Laid-Open No. 2020-154832 discloses a method of limiting server functions available in a network filter function to the minimum necessary for a communication interface.

In some server-configurable information devices, the initial state of the server functions is enabled for convenience at the time of introduction.

On the other hand, when a server-configurable information device is connected to a serverless computing environment, in order to reduce an attack risk from the network, it is desirable to disable the server functions by using a technology of applying a network filter to the communication interface described above. In this case, since the functions of the information device are restricted, it is desirable for the administrator of the information device to perform setting for restricting the use of the server functions.

However, when connecting an information device whose server functions are enabled to the serverless computing environment in an initial state, an administrator of the information device may be unaware of necessity of restricting use of the server functions. In such a case, there is a problem that the server functions of the information device are not disabled, which it is undesirable from the viewpoint of an attack risk via the network.

### SUMMARY OF THE INVENTION

The present invention enables realization of a technique of notifying an administrator of an information device of necessity of restricting use of server functions when connecting an information device whose server functions are enabled to the serverless computing environment.

One aspect of the present invention provides a server-configurable information processing apparatus, comprising: one or more first memory devices that store a set of instructions; and one or more first processors that execute the set of instructions to: perform a setting whether server functions are enabled or disabled, perform a setting whether or not to connect the information processing apparatus to a serverless computing environment, and give notification prompting a user to change a setting so as to restrict use of the server functions in the serverless computing environment when the server functions are set to be enabled and the information processing apparatus is set to be connected to the serverless computing environment.

Another aspect of the present invention provides a method for network setting of a server-configurable information processing apparatus, the method comprising: performing a setting whether server functions are enabled or disabled, performing a setting whether or not to connect the information processing apparatus to a serverless computing environment, and giving notification prompting a user to change a setting so as to restrict use of the server functions in the serverless computing environment when the server functions are set to be enabled and the information processing apparatus is set to be connected to the serverless computing environment.

Still another aspect of the present invention provides a non-transitory computer-readable storage medium, the storage medium storing a program for causing a computer to execute each step of a method for network setting of a server-configurable information processing apparatus, the method comprising: performing a setting whether server functions are enabled or disabled, performing a setting whether or not to connect the information processing apparatus to a serverless computing environment, and giving notification prompting a user to change a setting so as to restrict use of the server functions in the serverless computing environment when the server functions are set to be enabled and the information processing apparatus is set to be connected to the serverless computing environment.

### BRIEF DESCRIPTION OF THE DRAWINGS

FIG. 1 is a view illustrating an example of a connection mode of an MFP, a client terminal, and a gateway according to one embodiment of the present invention.

FIG. 2 is a hardware configuration diagram of the MFP according to one embodiment of the present invention.

FIG. 3 is a view illustrating an example of a software configuration of the MFP according to one embodiment of the present invention.

FIGS. 4A and 4B are views illustrating a configuration example of a setting screen according to one embodiment of the present invention.

FIGS. 5A to 5C are views illustrating a configuration example of the setting screen according to one embodiment of the present invention.

FIGS. 6A to 6D are views illustrating a configuration example of the setting screen according to one embodiment of the present invention.

FIGS. 7A to 7D are views illustrating a configuration example of the setting screen according to one embodiment of the present invention.

FIG. 8 is a view illustrating a configuration example of a network filter table according to one embodiment of the present invention.

FIG. 9 is a view illustrating a configuration example of the setting screen according to one embodiment of the present invention.

FIGS. 10A and 10B are flowcharts of processing of the MFP according to one embodiment of the present invention.

FIG. 11 is a flowchart of processing of the MFP according to one embodiment of the present invention.

FIGS. 12A to 12D are views illustrating a configuration example of the notification screen according to one embodiment of the present invention.

FIGS. 13A and 13B are views illustrating a configuration example of the notification screen according to one embodiment of the present invention.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

In the present embodiment, an example of controlling network settings of a multi-function peripheral (MFP) having two communication lines of a primary line and a secondary line will be described as an example. The MFP will be described as an example, but the present invention is not limited to the MFP, and may be an information processing apparatus that provides other functions. Here, an MFP having two communication lines will be described as an example, but the present invention is a technology applicable also to an MFP having one or more communication lines. Physically different communication lines will be described as an example here, but the present invention is a technology applicable also to virtually separated communication lines using a virtual network interface.

### System Configuration

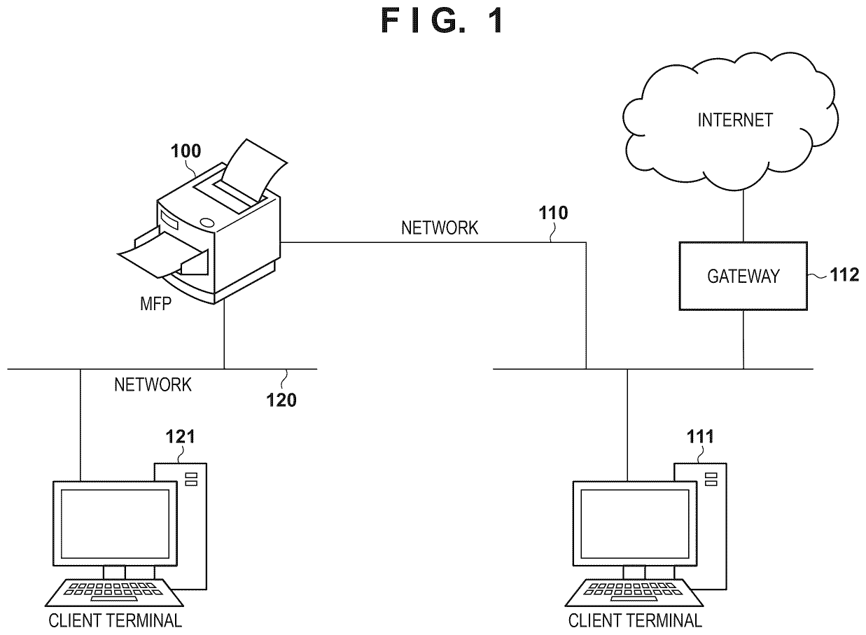

A network connection configuration of the MFP, the client terminal, and the gateway according to the present embodiment will be described with reference to FIG. 1. An MFP 100 is connected to two communication lines of a network 110 and a network 120. The network 110 is connected to the Internet. On the other hand, the network 120 is a normal LAN. The MFP 100 and a client terminal 111 are each connected to the network 110 and can communicate with each other. The MFP 100 and the client terminal 111 can communicate with the Internet via a gateway 112. The MFP 100 and a client terminal 121 are communicably connected to each other via the network 120.

The MFP 100 is a multi-function peripheral having a plurality of functions such as a scanner and a printer, and can transmit and receive data to and from the client terminals 111 and 121 and transmit and receive data to and from a cloud service not illustrated connected via the Internet. The client terminals 111 and 121 are, for example, a personal computer, a smartphone, or the like, and can transmit a print request to the MFP 100 and transmit and receive data to and from a cloud service not illustrated connected via the Internet. The gateway 112 is a network router that relays, with the Internet, communication from the MFP 100 and the client terminal 111. The networks 110 and 120 are communication networks. The network may be wired or wireless as long as data can be transmitted and received.

Note that the following description assumes that the MFP 100 and the client terminal 111 transmit and receive data only to and from a cloud service not illustrated connected via the Note that internet without using server functions of an information device connected to the network 110. It is assumed that there are no information devices including the client terminal 111 that use server functions of the MFP 100 via the network 110. That is, it is assumed that a network environment including the MFP 100, the network 110, the client terminal 111, the gateway 112, and the Internet is a serverless computing environment in the present embodiment.

### Hardware Configuration of MFP

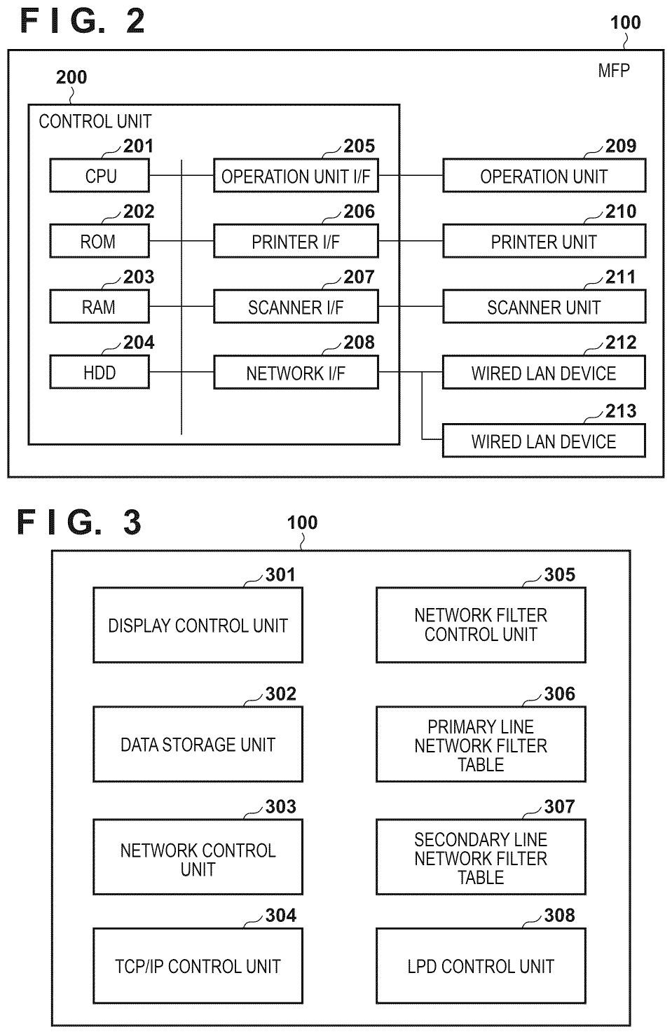

A hardware configuration of the MFP 100 will be described with reference to FIG. 2. The MFP 100 includes a control unit 200, an operation unit 209, a printer unit 210, a scanner unit 211, and wired LAN devices 212 and 213. The control unit 200 includes a CPU 201, a ROM 202, a RAM 203, an HDD 204, an operation unit I/F 205, a printer I/F, a scanner I/F, and a network I/F 208, and controls the entire operation of the MFP 100. The CPU 201 reads a control program stored in the ROM 202, and executes and controls various functions of the MFP 100 such as reading, printing, and communication. The RAM 203 is used as a temporary storage area such as a main memory and a work area of the CPU 201. Note that the present embodiment assumes that one CPU 201 executes processing shown in flowcharts described later using one memory (the RAM 203 or the HDD 204), but the present invention is not limited to this. For example, a plurality of CPUs or a plurality of RAMs or HDDs may cooperate to execute each processing.

The HDD 204 is a mass storage unit that stores image data and various programs. The operation unit I/F 205 is an interface that connects the operation unit 209 and the control unit 200. The operation unit 209 includes a touch panel and a keyboard, and receives an operation/input/instruction by a user. The printer I/F 206 is an interface that connects the printer unit 210 and the control unit 200. The image data for printing is transferred from the control unit 200 to the printer unit 210 via the printer I/F 206, and is printed on a recording medium. The scanner I/F 207 is an interface that connects the scanner unit 211 and the control unit 200. The scanner unit 211 reads a document set on a document table not illustrated or an auto document feeder (ADF) to generate image data, and inputs the image data to the control unit 200 via the scanner I/F 207. The MFP 100 can print (copy), from the printer unit 210, image data generated by the scanner unit 211, as well as transmitting the image data by e-mail.

The network I/F 208 is an interface that connects the control unit 200 (MFP 100) to the wired devices 212 and 213. The present embodiment will be described on an assumption of a mode in which two wired LAN devices 212 and 213 are connected to the network I/F 208. However, the present invention is not limited to this, and can also be applied to other LAN devices such as a wireless LAN device and a LAN device connected to a universal serial bus (USB), and other connection modes. The control unit 200 implements communication on the network 110 by controlling the wired LAN device 212 via the network I/F 208. The control unit 200 implements communication on the network 120 by controlling the wired LAN device 213.

### Software Configuration

A software configuration executed by the control unit 200 of the MFP 100 will be described with reference to FIG. 3. Each function of software executed by the control unit 200 is implemented by the CPU 201 reading and executing a control program stored in the ROM 202 or the HDD 204 into the RAM 203.

A display control unit 301 displays a screen for the user on the operation unit 209 of the MFP 100, detects a user operation, and executes processing associated with screen components such as buttons displayed on the screen. A data storage unit 302 stores various data in and reads them to the HDD 204 or the ROM 202 based on a request from another control unit. For example, when the user desires to change some device settings, the display control unit 301 detects and acquires content input by the user to the operation unit 209, and the data storage unit 302 saves the content in the HDD 204 as setting values based on a request from the display control unit 301.

A network control unit 303 gives a TCP/IP control unit 304 an instruction for network settings such as an IP address at the time of system activation or settings change detection in accordance with the setting values stored in the data storage unit 302. The TCP/IP control unit 304 performs transmission/reception processing of network packets via the network I/F 208 in accordance with an instruction from another control. A network filter control unit 305 performs filtering processing on packets transmitted and received in accordance with an instruction from the TCP/IP control unit 304.

A primary line network filter table 306 and a secondary line network filter table 307 hold a rule for the network filter control unit 305 to determine whether to accept or discard a target packet. The description of the present embodiment assumes that the rule is defined in advance.

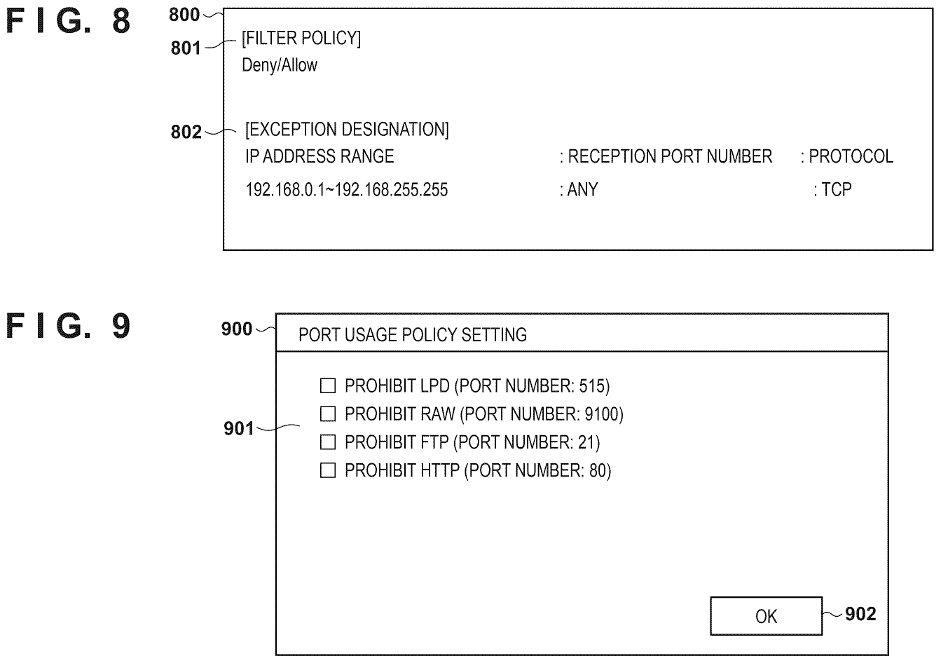

Here, a rule used for determination of filtering processing of a packet will be described with reference to FIG. 8. The primary line network filter table 306 and the secondary line network filter table 307 hold information presented in FIG. 8. A network filter table 800 is a table that exists for each line. In the present embodiment, the primary line network filter table 306 is a filter table for a primary line, and the secondary line network filter table 307 is a filter table for a secondary line.

In the network filter table 800, two types of values of “Deny/Allow” or “Allow/Deny” are designated as a filter policy 801. The case of “Deny/Allow” is a whitelist scheme that prohibits all communications and permits those corresponding to exception designation. The case of “Allow/Deny” is a blacklist scheme that permits all communications and prohibits those corresponding to exception designation. Exception designation 802 is data in a list format listing exception rules including an “IP address range”, a “reception port number”, and a “protocol”. The “IP address range” designates the range of an IP address to which the exception rule is applied. The “reception port number” designates a port number to which the exception rule is applied or “ANY”, which indicates all port numbers. The “protocol” designates, from “TCP” or “UDP”, a protocol to which the exception rule is applied.

The description returns to FIG. 3. An LPD control unit 308 controls LPD server functions in accordance with an instruction from the network control unit 303. Specifically, a print request is received from a client terminal such as a client PC 121 by performing communication using a line printer daemon protocol (LPD protocol) as a LPD server. In the present embodiment, the LPD protocol is taken as an example of the server functions related to printing, but the MFP 100 may also have server functions of other protocols. Examples of the protocol related to printing include RAW, server message block (SMB), and hypertext transfer protocol (HTTP) in addition to the LPD. Examples of the protocol related to management of the MFP include simple network management protocol (SNMP) and multicast DNS (mDNS).

### Screen Configuration

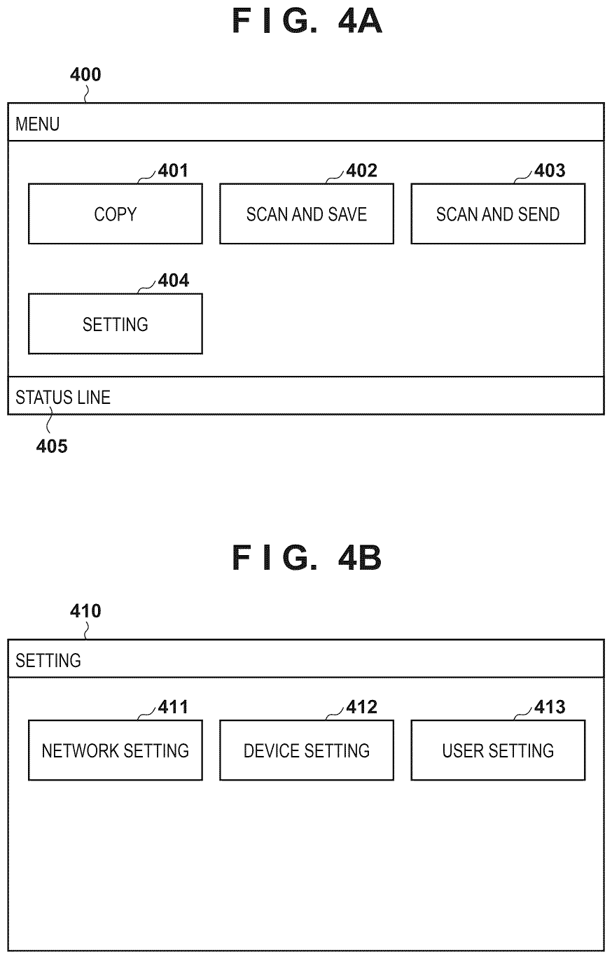

Hereinafter, an example of a screen configuration according to the present embodiment will be described with reference to FIGS. 4A to 7D. Note that the screen configuration and screen transition presented below are examples, and other configurations may be adopted.

FIG. 4A illustrates a configuration example of a menu screen 400 displayed on the operation unit 209, and is for the user to instruct execution of various functions of the MFP 100. A copy button 401 is used by the user to instruct copy functions. A scan and save button 402 is used by the user to instruct functions of scanning and saving. A scan and send button 403 is used by the user to instruct functions of scanning and sending. A setting button 404 is used by the user to instruct changes of settings of the device. When the setting button 404 is operated, a setting screen 410 illustrated in FIG. 4B is displayed. A status line 405 displays a message indicating a state such as a remaining amount of consumables of the MFP and an error occurrence status, and is used to notify the user of the state of the MFP 100.

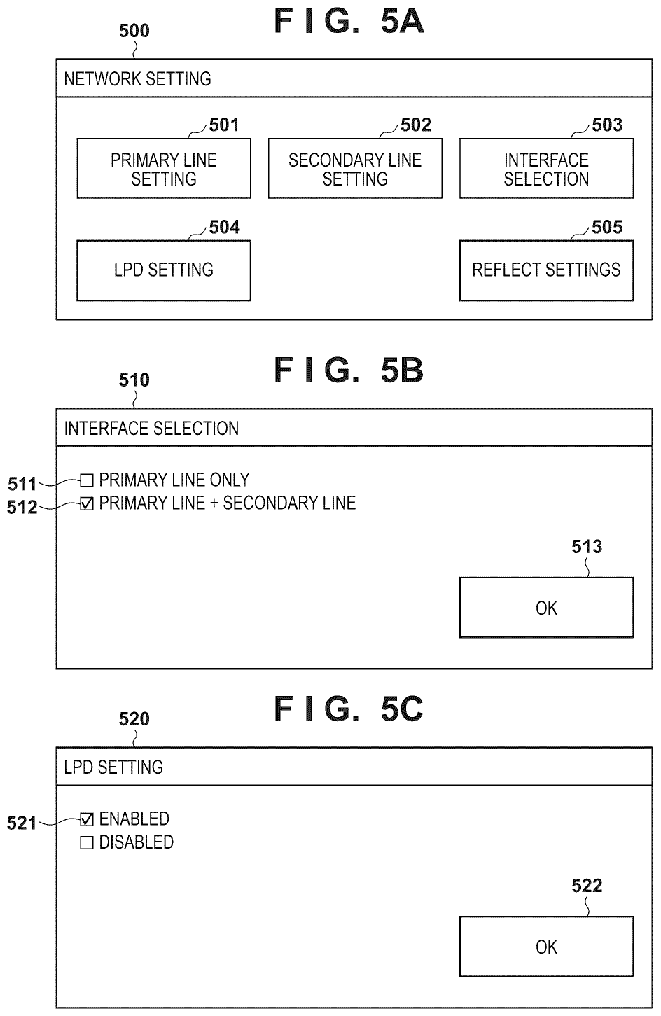

FIG. 4B illustrates a configuration example of the setting screen 410 displayed on the operation unit 209, and is for the user to instruct various settings. This setting screen 410 itself has no specific setting items, and is an intermediate hierarchy serving as a guide for detailed setting items. When a network setting button 411 is operated, a network setting screen 500 illustrated in FIG. 5A is displayed. When a device setting button 412 is operated, a device setting screen (not illustrated) is displayed. When a user setting button 413 is operated, a user setting screen (not illustrated) is displayed. A device setting method using the device setting screen and a user setting method using the user setting screen are not particularly limited.

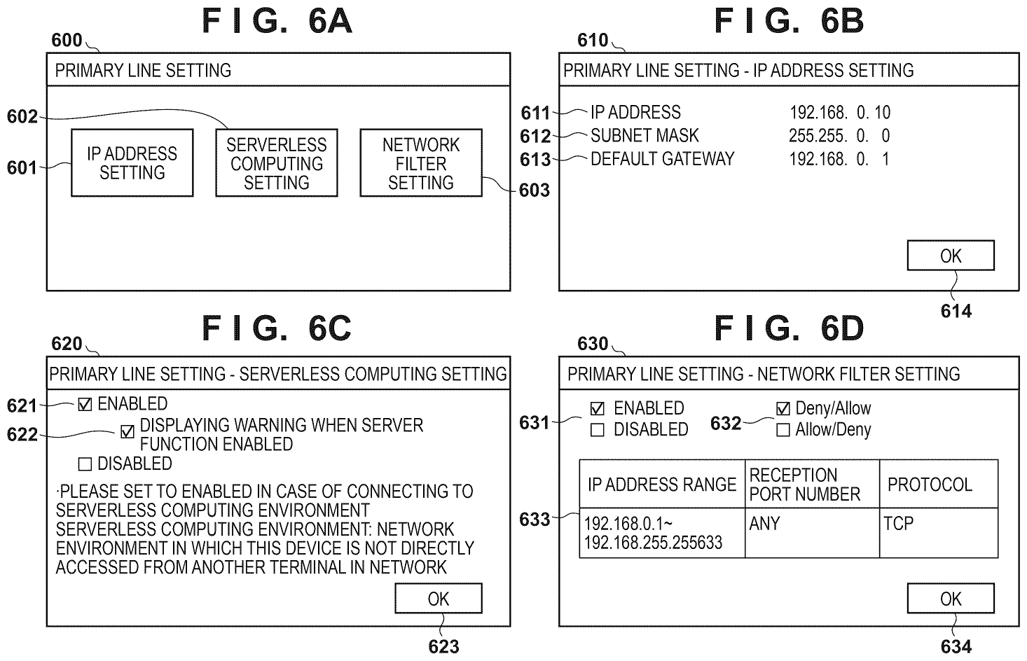

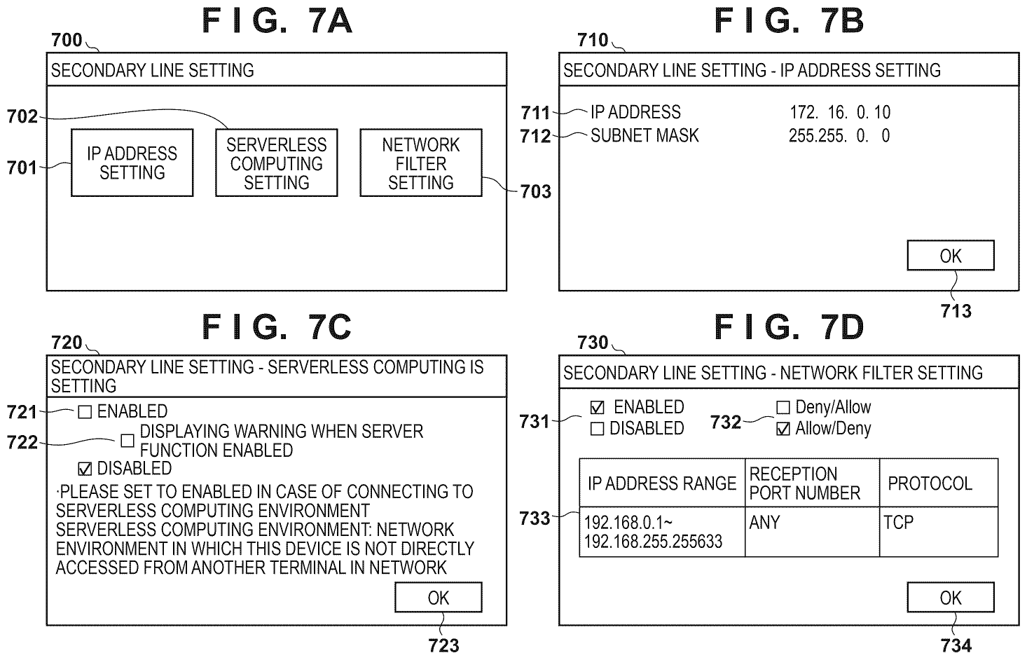

FIG. 5A illustrates a configuration example of the network setting screen 500 displayed on the operation unit 209, and is an intermediate hierarchy for the user to perform various network settings. When an interface selection button 503 is operated, an interface selection setting screen 510 illustrated in FIG. 5B is displayed. When an LPD setting button 504 is operated, an LPD setting screen 520 illustrated in FIG. 5C is displayed. When a primary line setting button 501 is operated, a primary line setting screen 600 illustrated in FIG. 6A is displayed. When a secondary line setting button 502 is operated, a secondary line setting screen 700 illustrated in FIG. 7A is displayed. When a setting reflection button 505 is operated, the setting selected by the user is stored in the data storage unit 302, and then a reflection instruction of the setting is given to the network control unit 303.

FIG. 5B illustrates a configuration example of the interface selection setting screen 510 according to the present embodiment, and whether the MFP 100 uses one or two communication lines can be selected. When an OK button 513 is operated, the setting content of the interface selection setting screen 510 is saved in the data storage unit 302. As described above, two of the primary line and the secondary line can be used as the communication lines according to the present embodiment. When “primary line only” 511 is selected on the interface selection setting screen 510, only the wired LAN device 212 is enabled. When “primary line+secondary line” 512 is selected, the wired LAN device 212 and the wired LAN device 213 are enabled simultaneously. In the present embodiment, a configuration in which only the wired LAN device 213 is enabled (a configuration in which only the secondary line is enabled) is not provided, but the present invention is also applicable to a configuration in which only the secondary line is provided.

When the “primary line +secondary line” 512 is selected, the wired LAN device 212 is set as a primary line and the wired LAN device 213 is set as a secondary line. The difference between the primary line and the secondary line is, for example, a difference in priority in a case where either operation needs to be stopped. Specifically, when the same IP address is allocated to the primary line and the secondary line, the primary line and the secondary line cannot be operated simultaneously, and therefore the network control unit 303 disables the secondary line to control the primary line to continue the operation. In addition, when a function difference is required due to a communication protocol or an application restriction, the primary line and the secondary line have different functions. Note that the present embodiment is not limited to classification of the primary line and the secondary line, and for example, in a case of a device compatible with more lines (communication interfaces), different operations may be defined in accordance with the use of each line. The present embodiment will be described on an assumption that the primary line is connected to the above-described serverless computing environment. Note that the line connected to the serverless computing environment is not limited to the primary line, and the present invention is also applicable to a case where the secondary line is connected to the serverless computing environment.

FIG. 5C illustrates a configuration example of the LPD setting screen 520 displayed on the operation unit 209, and is used by the user to instruct the settings of the LPD server functions. An LPD active state designation section 521 designates whether to enable or disable the LPD server functions of the MFP 100. The enabled/disabled setting here is a mutually exclusive option. When the LPD setting is enabled, it indicates that the LPD server functions are available in the MFP 100. When an OK button 522 is operated, the item selected on the LPD setting screen 520 is saved in the data storage unit 302. Note that in the present embodiment, the LPD function will be described as an example, but in a case where the MFP 100 is server-configurable in addition to the LPD function, it goes without saying that a setting screen for setting enable/disable of the server functions is provided similarly to the LPD setting screen 520.

FIG. 6A illustrates a configuration example of the primary line setting screen 600 displayed on the operation unit 209, and is an intermediate hierarchy for performing setting for the primary line. When an IP address setting button 601 is operated, a primary line IP address setting screen 610 illustrated in FIG. 6B is displayed. When a serverless computing setting button 602 is operated, a primary line serverless computing setting screen 620 illustrated in FIG. 6C is displayed. When a network filter setting button 603 is operated, a primary line network filter setting screen 630 illustrated in FIG. 6D is displayed.

FIG. 6B illustrates a configuration example of the primary line IP address setting screen 610 displayed on the operation unit 209, and is used by the user to instruct IP address-related settings for the primary line. An IP address input section 611 allows the user to input an arbitrary IP address as an IP address for the primary line. A subnet mask input section 612 allows the user to input an arbitrary subnet mask as a subnet mask for the primary line. A default gateway input section 613 allows the user to input an arbitrary default gateway as a default gateway for the primary line. In the present embodiment, the IP address of the gateway 112 is input as a value of the default gateway input section 613. When an OK button 614 is operated, the value of the item selected on the primary line setting screen 610 is saved in the data storage unit 302.

FIG. 6C illustrates a configuration example of the primary line serverless computing setting screen 620 displayed on the operation unit 209, and is used by the user to instruct whether or not the network environment to which the primary line is connected is a serverless computing environment and settings related thereto. A serverless computing setting section 621 designates whether or not the network environment to which the primary line is connected is a serverless computing environment. The enabled/disabled setting here is a mutually exclusive option. When enabled, it indicates that the primary line is connected to the serverless computing environment. A warning designation section 622 alternatively designates whether or not to display a warning when the server functions of the MFP 100 are available in the serverless computing environment. Specifically, when the serverless computing setting section 621 is designated to be “enabled” and a server function such as the LPD function described above is available from a network of the primary line side, the warning designation section 622 alternatively designates whether or not display a warning. The warning designation section 622 indicates displaying the above-described warning when a check box is checked. The warning designation section 622 is a setting item that can be selected when the serverless computing setting section 621 is designated to be enabled. When an OK button 623 is operated, the item selected on the primary line serverless computing setting screen 620 is saved in the data storage unit 302.

FIG. 6D illustrates a configuration example of the primary line network filter setting screen 630 displayed on the operation unit 209, and is used by the user to instruct settings of the network filter for the primary line. On the primary line network filter setting screen 630, an initial value is set and presented, and the user can change the value thereof. An active state designation section 631 designates whether to enable or disable the settings of the network filter for the primary line. The enabled/disabled setting here is a mutually exclusive option. When disabled, all network packets are received without being discarded. When enabled, the network filtering processing for the primary line is performed in accordance with the rule designated on the primary line network filter setting screen 630. A filter policy designation section 632 allows the user to designate the filter policy described with reference to FIG. 8 for the primary line. The setting of “Deny/Allow”/“Allow/Deny” here is an alternative setting item. A network filter rule 633 is an area for displaying and inputting exception designation currently set for the primary line. The exception designation here corresponds to that described with reference to FIG. 8. When an OK button 634 is operated, the item selected on the primary line network filter setting screen 630 is saved in the data storage unit 302.

FIG. 7A illustrates a configuration example of the secondary line setting screen 700 displayed on the operation unit 209, and is an intermediate hierarchy for performing setting for the secondary line. When an IP address setting button 701 is operated, a secondary line IP address setting screen 710 illustrated in FIG. 7B is displayed. When a serverless computing setting button 702 is operated, a secondary line serverless computing setting screen 720 illustrated in FIG. 7C is displayed. When a network filter setting button 703 is operated, a secondary line network filter setting screen 730 illustrated in FIG. 7D is displayed.

FIG. 7B illustrates a configuration example of the secondary line IP address setting screen 710 displayed on the operation unit 209, and is used by the user to instruct IP address-related settings for the secondary line. An IP address input section 711 allows the user to input an arbitrary IP address as an IP address for the secondary line. A subnet mask input section 712 allows the user to input an arbitrary subnet mask as a subnet mask for the secondary line. When an OK button 713 is operated, the value of the item selected on the secondary line setting screen 710 is saved in the data storage unit 302.

FIG. 7C illustrates a configuration example of the secondary line serverless computing setting screen 720 displayed on the operation unit 209, and is used by the user to instruct whether or not the network environment to which the secondary line is connected is a serverless computing environment and settings related thereto. A serverless computing setting section 721 designates whether or not the network environment to which the secondary line is connected is a serverless computing environment. The enabled/disabled setting here is a mutually exclusive option. When enabled, it indicates that the secondary line is connected to the serverless computing environment. A warning designation section 722 alternatively designates whether or not to display a warning when the server functions of the MFP 100 are available in the serverless computing environment. Specifically, when the serverless computing setting section 721 is designated to be “enabled” and a server function such as the LPD function described above is available from a network of the secondary line side, the warning designation section 721 alternatively designates whether or not display a warning. The warning designation section 722 indicates displaying the above-described warning when a check box is checked. The warning designation section 722 is a setting item that can be selected when the serverless computing setting section 721 is designated to be enabled. When an OK button 723 is operated, the item selected on the secondary line serverless computing setting screen 720 is saved in the data storage unit 302.

FIG. 7D illustrates a configuration example of the secondary line network filter setting screen 730 displayed on the operation unit 209, and is used by the user to instruct settings of the network filter for the secondary line. On the secondary line network filter setting screen 730, an initial value is set and presented, and the user can change the value thereof. An active state designation section 731 designates whether to enable or disable the settings of the network filter for the secondary line. The enabled/disabled setting here is a mutually exclusive option. When disabled, all network packets are received without being discarded. When enabled, the network filtering processing for the secondary line is performed in accordance with the rule designated on the secondary line network filter setting screen 730. A filter policy designation section 732 allows the user to designate the above-described filter policy for the secondary line. The setting of “Deny/Allow”/“Allow/Deny” here is an alternative setting item. A network filter rule 733 is an area for displaying and inputting exception designation currently set for the secondary line. The exception designation here corresponds to that described with reference to FIG. 8. When an OK button 734 is operated, the item selected on the secondary line network filter setting screen 730 is saved in the data storage unit 302.

### Security Policy Settings

Here, the security policy will be described. The security policy is a basic policy regarding security of an entire organization, security countermeasure criteria, an individual specific implementation procedure, and the like. One of the security policies of a server-configurable device is port control (port usage policy) of the server functions. For the port usage policy, in order to reduce an attack risk from the network, it is common to formulate and operate a policy that prohibits use of server functions not used. When a server-configurable MFP is used by an organization that formulates and operates the port usage policy as described above, operation in accordance with the port usage policy is required.

The description returns to the embodiment. Settings of the security policy will be described with reference to FIG. 9. FIG. 9 illustrates a configuration example of a port usage policy setting screen 900 based on the security policy displayed on the operation unit 209. The port usage policy setting screen 900 is used by the user to give the MFP 100 an instruct as to availability of the server functions based on the port usage policy of the organization. A policy designation section 901 designates whether or not to prohibit use of each server function of the MFP 100. Checking a checkbox of the item of each server function indicates prohibition of use of the server function. For example, when the setting to prohibit LPD is made in FIG. 9, active state designation of the server functions such as the LPD active state designation section 521 is changed to “disabled”. An instruction of availability of the server functions in accordance with the security policy is prioritized over the designation of enable/disable of the server functions, and when the setting to prohibit LPD is made in FIG. 9, the instruction cannot be set to be enabled in the enable/disable of the LPD settings in FIGS. 5A to 5C. When an OK button 902 is operated, the item selected on the port usage policy setting screen 900 is saved in the data storage unit 302.

In an organization using the MFP 100, there is a case where permission and prohibition of use of various server functions are defined in the security policy. In such a case, availability of the server functions based on the security policy of the organization can be set in the MFP 100 by setting the policy designation section 901. If set, the security policy is prioritized over the settings of the server functions. In a case where the communication line used by the MFP 100 is the primary line and the secondary line, when the server functions are disabled by the settings of the server functions, the server functions are also disabled for lines other than serverless computing operation. Therefore, the use of the server functions needs to be restricted not by disabling them by the settings of the server functions but by setting network filters individually for the primary line and the secondary line to block communication to the MFP 100.

Method of restricting use of the server functions in a case of serverless computing operation of the MFP 100 include the following three methods. They are permission and prohibition of use of the server functions in accordance with the security policy, settings of enable/disable in settings of the server functions, and blocking of communication to the MFP 100 by settings of the network filter. In the above description, the user performs settings of enable or disable of the serverless computing settings, but the serverless computing mode (server function disabled) may be set as the security policy. The blocking of communication can also be implemented by applying reception rejection not in the settings of the server functions and the settings of the network filter but in the settings of a firewall.

### Processing Flow in First Embodiment

### Warning Notification Processing

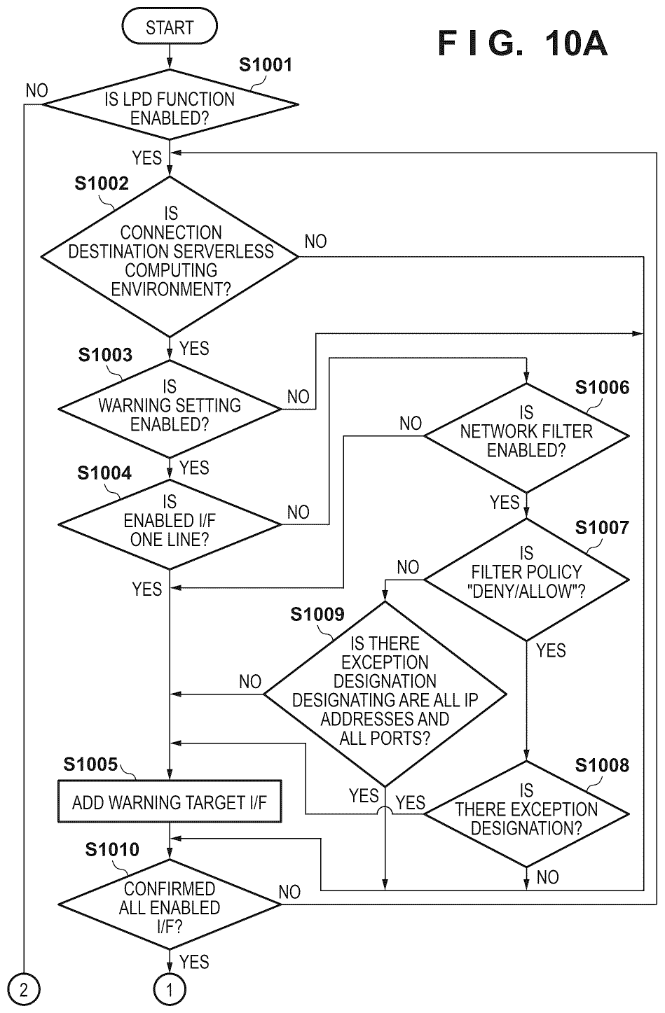

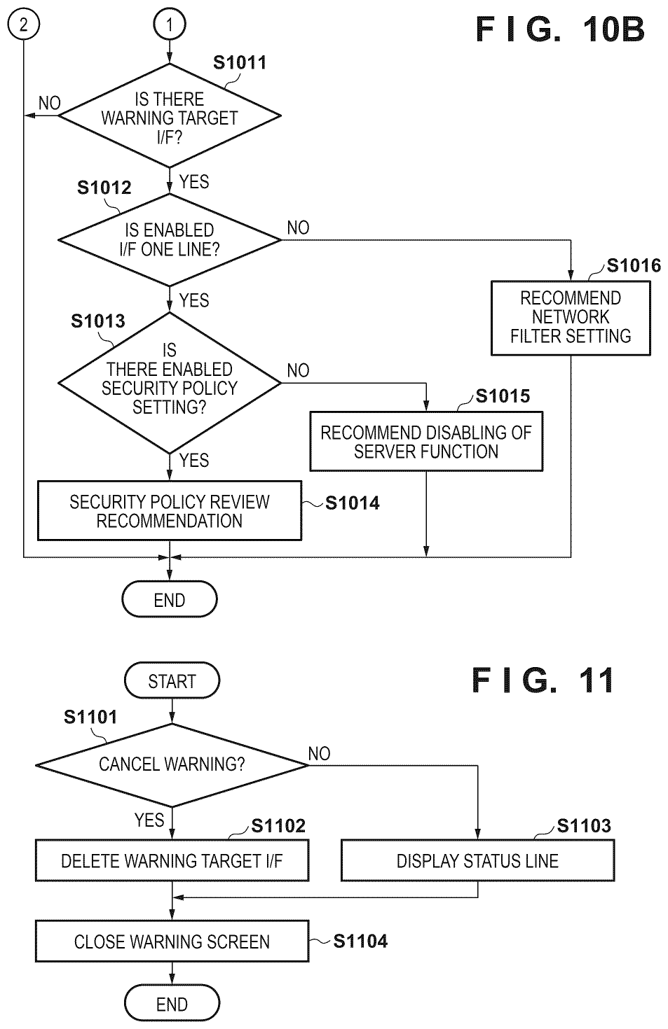

Warning notification processing of the MFP 100 when the server functions of the MFP 100 according to the present embodiment are available in the serverless computing environment will be described with reference to FIG. 10A and 10B. Each operation (step) shown in the flowchart of FIG. 10A and 10B is implemented by the CPU 201 of the MFP 100 reading a control program stored in the ROM 202 or the HDD 204 into the RAM 203 and executing the control program. Hereinafter, the step number of each process included in the flowchart is indicated by a number starting with “S”. The same applies to the subsequent flowcharts. This processing flow is started due to the button 505 on the network setting screen 500 illustrated in FIG. 5A being operated at the time of the system activation.

In S1001, the MFP 100 determines whether or not the LPD function is “enabled”. The determination is made by the network control unit 303 referring to the value corresponding to the LPD active state designation section 521 of the setting value saved in the data storage unit 302. If it is determined that the LPD function is enabled (YES in S1001), the process proceeds to S1002, and if it is determined that the LPD function is disabled (NO in S1001), this processing flow is ended. When the MFP 100 includes server functions in addition to the LPD, the network control unit 303 determines whether or not each server function is enabled similarly to S1001. In this case, if it is determined that any of the server functions of the MFP 100 is enabled, YES is determined in S1001.

A series of processing from S1002 to S1009 is hereinafter called warning notification determination processing. The warning notification determination processing is performed on the line selected on the interface selection setting screen 510. The confirmation as to which line among the used lines the warning notification determination processing has been performed up to is made by confirming the processing status internally held on the RAM 203. Here, description is given on an assumption that the warning notification determination processing is performed in order from the primary line.

In S1002, the MFP 100 determines whether or not the serverless computing setting of the primary line is “enabled”. The determination is made by the network control unit 303 referring to the value corresponding to the serverless computing setting section 621 of the setting value saved in the data storage unit 302. If it is determined that the serverless computing setting is enabled (YES in S1002), the process proceeds to S1003, and if it is determined that the serverless computing setting is disabled (NO in S1002), the process proceeds to S1010.

In S1003, the MFP 100 determines whether or not the warning notification of the primary line is “enabled”. The determination is made by the network control unit 303 referring to the value corresponding to the warning designation section 622 of the setting value saved in the data storage unit 302. If it is determined that the warning notification is enabled (YES in S1003), the process proceeds to S1004, and if it is determined that the warning notification is disabled (NO in S1003), the process proceeds to S1010.

In S1004, the MFP 100 determines whether the MFP 100 uses the number of the communication lines used by the MFP 100 is one or a plurality of two or more. The determination is made by the network control unit 303 referring to the value corresponding to the content of the interface selection setting screen 510 of the setting value saved in the data storage unit 302. If the “primary line only” 511 is selected, it is determined as “one”. If the “primary line +secondary line” 512 is selected, it is determined as “plurality”. If the number of communication lines is determined to be “one” (YES in S1004), the process proceeds to S1005, and if the number of communication lines is determined to be a “plurality” (NO in S1004), the process proceeds to S1006. The case of YES in this S1004 indicates that the MFP 100 is connected to the serverless computing environment but the server functions are enabled.

In S1005, the MFP 100 adds the primary line to a warning target interface. Specifically, the network control unit 303 adds the primary line to interface information of the warning target internally held in the RAM 203.

In S1006, the MFP 100 determines whether or not the network filter of the primary line is “enabled”. The determination is made by the network control unit 303 referring to the value corresponding to the active state designation section 631 on the primary line network filter setting screen 630 of the setting value saved in the data storage unit 302. If it is determined that the network filter is enabled (YES in S1006), the process proceeds to S1007, and if it is determined that the network filter is disabled (NO in S1006), the process proceeds to S1005.

In S1007, the MFP 100 determines whether or not the filter policy of the primary line is “Deny/Allow”. The determination is made by the network control unit 303 referring to the value corresponding to the filter policy designation section 632 on the primary line network filter setting screen 630 of the setting value saved in the data storage unit 302. If the filter policy is determined to be “Deny/Allow” (YES in S1007), the process proceeds to S1008, and if the filter policy is determined to be “Allow/Deny” (NO in S1007), the process proceeds to S1009.

In S1008, the MFP 100 confirms whether or not there is exception designation for the primary line. As a confirmation method, the network control unit 303 acquires the value corresponding to the network filter rule 633 among the settings saved in the data storage unit 302. Since the network filter rule 633 is an ordered list, the exception designation is determined to be “present” when a network filter entry is acquired. If the exception designation is determined to be “present” (YES in S1008), the process proceeds to S1005, and if the exception designation is determined to be “absent” (NO in S1008), the process proceeds to S1010. The case of YES in this S1008 indicates that the server functions of the MFP 100 are available from the serverless computing environment to which the primary line is connected by exception designation of the network filter of a whitelist scheme.

In S1009, the MFP 100 confirms the presence or absence of exception designation in which the entire IP address range “0.0.0.1 to 255.255.255.255” and “ANY”, which indicates all port numbers, are designated. As a confirmation method, the network control unit 303 acquires the value corresponding to the network filter rule 633 among the settings saved in the data storage unit 302. Since the network filter rule 633 is an ordered list, the content of the filter entries from the head to the tail is confirmed. If the exception designation is determined to be “present” (YES in S1009), the process proceeds to S1010, and if the exception designation is determined to be “absent” (NO in S1009), the process proceeds to S1005. The case of YES in this S1009 indicates that all communications are prohibited by exception designation of the network filter of a blacklist scheme, and that the server functions of the MFP 100 are unavailable from the serverless computing environment to which the primary line is connected.

In S1010, the MFP 100 confirms whether the warning notification determination processing has been performed on all the used lines selected on the interface selection setting screen 510. In the confirmation, the network control unit 303 confirms the processing status internally held on the RAM 203. If the warning notification determination processing has been performed on all the used lines (YES in S1010), the process proceeds to S1011. If the warning notification determination processing has not been performed on all the used lines (NO in S1010), the processing returns to S1002, and the warning notification determination processing is performed on a line on which the warning notification determination processing has not been performed. In the present embodiment, if the “primary line +secondary line” 512 is selected on the interface selection setting screen 510, NO is determined in S1010, and the series of processing from S1002 to S1009 is performed on the secondary line in the same manner as described above.

In S1011, the MFP 100 determines the presence or absence of an interface determined to be a warning target in the warning notification determination processing. The determination is made by the network control unit 303 referring to the interface information of the warning target internally held in the RAM 203. If there is an interface determined to be a warning target (YES in S1011), the process proceeds to S1012, and if there is no interface determined to be a warning target, this processing flow is ended.

In S1012, it is determined whether the MFP 100 uses the number of the communication lines used by the MFP 100 is one or a plurality of two or more. If the communication lines used by the MFP 100 are the primary line and the secondary line, when the server functions are disabled by settings of the server functions, the server functions are disabled for lines other than the serverless computing operation. Therefore, the use of the server functions needs to be restricted not by disabling them by the settings of the server functions but by setting network filters individually for the primary line and the secondary line to block communication. The determination method is the same as that in S1004. If it is determined that there is “one” communication line that is used (YES in S1012), the process proceeds to S1013, and if it is determined that there are a “plurality of” communication lines (NO in S1012), the process proceeds to S1016.

In S1013, the MFP 100 determines whether or not a security policy is set. This is because when the security policy is set, the settings of prohibition of the server functions in the setting of the port usage policy of the security policy have priority over the settings of the server functions. The determination is made by the network control unit 303 referring to the value corresponding to the policy designation section 901 of the port usage policy setting among the settings saved in the data storage unit 302. If at least one item of the setting items of the policy designation section 901 is “enabled”, it is determined that the security policy is set. If it is determined that the security policy is set (YES in S1013), the process proceeds to S1014, and if it is determined that the security policy is not set (NO in S1013), the process proceeds to S1015.

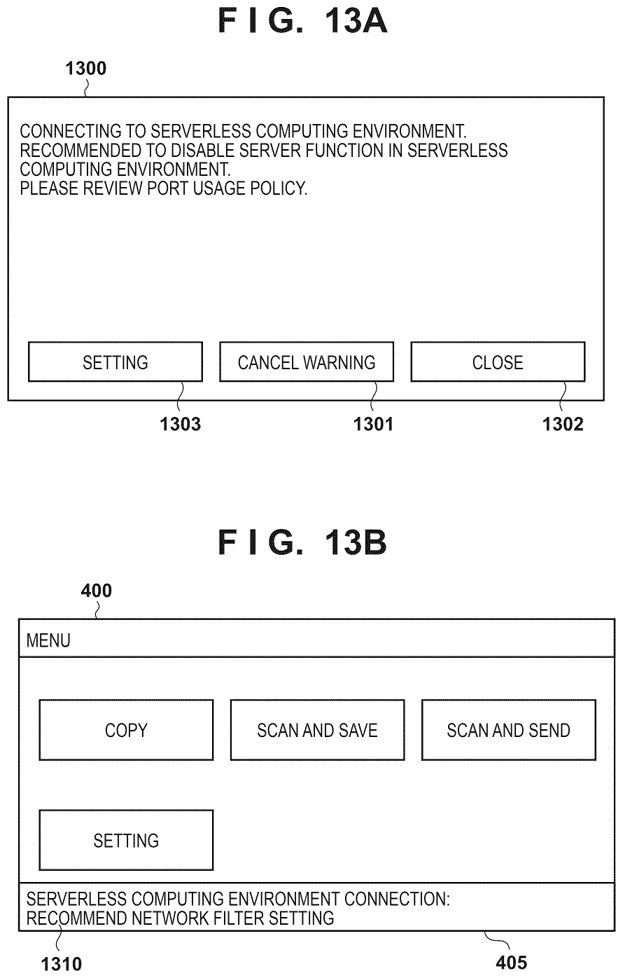

In S1014, the MFP 100 displays a security policy setting review warning screen 1300 (FIG. 13A). The security policy setting review warning screen 1300 will be described later. As a display method, the network control unit 303 requests the display control unit 301 to display the security policy setting review warning screen 1300 on the operation unit 209. Then, this processing flow is ended.

When the security policy is set in the MFP 100, there is a possibility that permission and prohibition of use of each server functions are defined in the security policy of the organization using the MFP 100. In the case of connecting to the serverless computing environment, it is desirable to change the settings of all the server function settings to be prohibited so that the server functions are not used. The user needs to review the policy setting of the port usage policy of the MFP 100 after confirming whether the setting change does not violate the security policy of the organization. Therefore, by displaying the security policy setting review warning screen 1300 in S1014, the user can recognize that it is necessary to review the policy designation of the port usage policy. When reviewing the policy setting of the port usage policy, the user who has recognized changes the setting of the policy on the port usage policy setting screen 900.

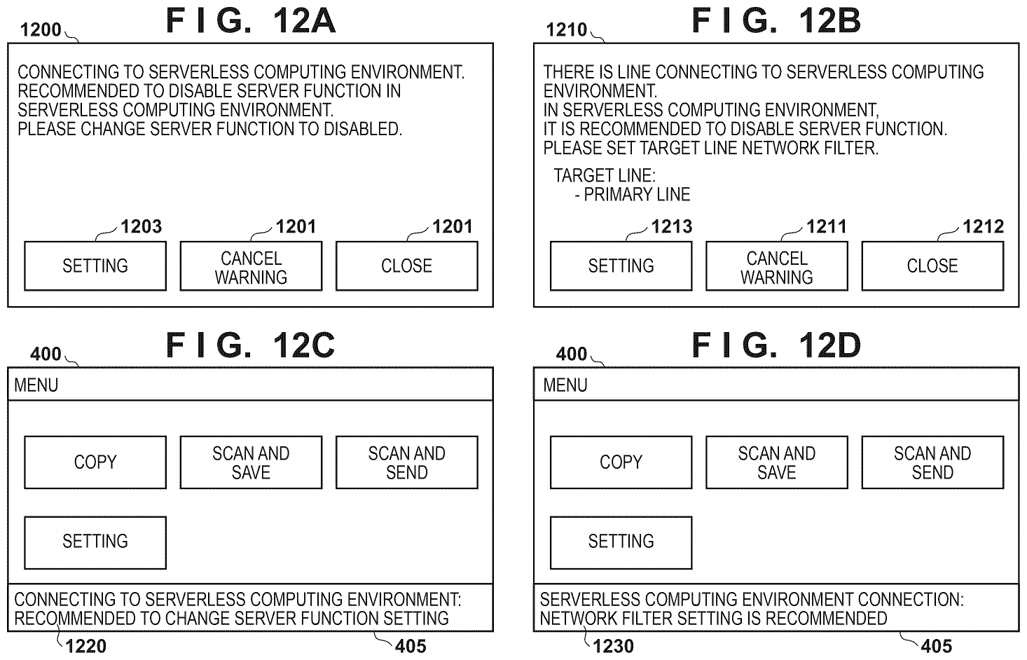

In S1015, the MFP 100 displays a warning screen 1200 (FIG. 12A) recommending disabling of the server functions. The warning screen 1200 recommending disabling of the server functions will be described later. As a display method, the network control unit 303 requests the display control unit 301 to display the warning screen 1200 on the operation unit 209. Then, this processing flow is ended.

In S1016, the MFP 100 displays a warning screen 1210 (FIG. 12B) recommending network filter settings. The warning screen 1210 recommending network filter settings will be described later. As a display method, the network control unit 303 requests the display control unit 301 to display the warning screen 1210 on the operation unit 209. Then, this processing flow is ended.

By S1015 and S1016, the MFP 100 is connected to the serverless computing environment, and the user can recognize that it is desirable to make the server functions unavailable from the serverless computing environment. Furthermore, the user can know whether to change the setting of each server function to be “disabled” or whether to set the network filter of the line connected to the serverless computing environment in order to make the server functions unavailable from the serverless computing environment.

### Warning Notification Screen Control Processing

Control processing of the warning notification screen of the MFP 100 according to the present embodiment will be described with reference to FIG. 11, FIGS. 12A to 12D, and FIGS. 13A and 13B. Each operation (step) shown in the flowchart of FIG. 11 is implemented by the CPU 201 of the MFP 100 reading a control program stored in the ROM 202 or the HDD 204 into the RAM 203 and executing the control program. The processing flow of FIG. 11 is started when any of the warning screens 1200, 1210, and 1300 is displayed.

FIG. 12A is a configuration example of a setting warning screen of the server functions in the serverless computing environment. The setting warning screen 1200 of the server functions displays a message indicating that the settings of the server functions should be disabled because the connection to the serverless computing environment is established. When a warning cancel button 1201 is operated, the setting warning screen 1200 of the server functions is closed. The warning cancel button 1201 is an example of the first object in the present invention. When a close button 1202 is operated, a setting warning screen 1200 of the server functions is closed, and a warning message 1220 is displayed on a status line section 405 of the menu screen 400. The close button 1202 is an example of the second object in the present invention. Unless the warning cancel button 1201 is operated or the server functions are disabled, the warning message 1220 is displayed on the status line section 405. When a setting button 1203 is operated, the screen transitions to the LPD setting screen 520 of FIG. 5C for setting enabling/disabling of the server functions. The user can disable the server functions on the LPD setting screen 520. The setting button 1203 is an example of the third object in the present invention.

FIG. 12B is a configuration example of a warning screen recommending network filter settings in the serverless computing environment. The network filter setting warning screen 1210 displays a message indicating that the network filter settings should be performed because the connection to the serverless computing environment is established and a target line. When a warning cancel button 1211 is operated, the network filter setting warning screen 1210 is closed. The warning cancel button 1211 is an example of the first object in the present invention. When a close button 1212 is operated, the network filter setting warning screen 1210 is closed, and a warning message 1230 is displayed on the status line section 405 of the menu screen 400. The close button 1212 is an example of the second object in the present invention. When a setting button 1213 is operated, the screen transitions to the primary line setting screen 600 of FIG. 6A. This allows the user to perform the network filter settings by operating the network filter setting button 603. The setting button 1213 is an example of the third object in the present invention. The example of FIG. 12B is regarding the primary line, but in the case of the secondary line, the screen transitions to the secondary line setting screen 700 of FIG. 7A by operating the setting button 1213. In the case of both the primary line and the secondary line, two buttons for transitioning to the primary line setting screen 600 and the secondary line setting screen 700 may be provided.

FIG. 12C is an example of status line display recommending a setting change of server functions in the serverless computing environment. The status line section 405 of the menu screen 400 described with reference to FIGS. 4A and 4B displays the warning message 1220 recommending the setting change of the server functions. When the warning message 1220 is operated, the warning screen 1200 is displayed.

FIG. 12D is an example of status line display recommending network filter settings in the serverless computing environment. The status line section 405 of the menu screen 400 described with reference to FIGS. 4A and 4B displays the warning message 1230 recommending the network filter settings. When the warning message 1230 is operated, the warning screen 1210 is displayed.

FIG. 13A is a configuration example of the security policy setting review warning screen. The security policy setting review warning screen 1300 displays a message recommending review of the security policy settings because connection to the serverless computing environment is established. Here, as a security policy, a message recommending review of the port usage policy of the server functions is displayed. When a warning cancel button 1301 is operated, the security policy setting review warning screen 1300 is closed. The warning cancel button 1301 is an example of a first object in the present invention. When a close button 1302 is operated, the security policy setting review warning screen 1300 is closed, and a warning message 1310 is displayed on the status line section 405 of the menu screen 400. The close button 1302 is an example of the second object in the present invention. When a setting button 1303 is operated, transition to the port usage policy setting screen 900 of FIG. 9 is performed, and the user can change the setting of the port usage policy and change the setting to prohibit the LPD, for example. The setting button 1303 is an example of the third object of the present invention.

FIG. 13B is an example of status line display recommending review of the security policy settings in the serverless computing environment. The status line section 405 of the menu screen 400 described with reference to FIGS. 4A and 4B displays the warning message 1310 recommending review of the security policy settings. Here, a message recommending review of the port usage policy similar to FIG. 13B is displayed. When the warning message 1310 is operated, the security policy setting review warning screen 1300 is displayed. The description returns to the flowchart of FIG. 11.

In S1101, the MFP 100 determines whether or not the warning has been canceled on the warning screen. In the determination, the network control unit waits for the warning cancel button (1201, 1211, or 1301) and the close button (1202, 1212, or 1302) of each warning screen to be operated. If the warning cancel button (1201, 1211, or 1301) is operated, it is determined as “canceled”. When the close button (1202, 1212, or 1302) is operated, it is determined as “not canceled”. If the warning is determined to be “canceled” (YES in S1101), the process proceeds to S1102. Otherwise (NO in S1101), the process proceeds to S1103.

In S1102, the MFP 100 deletes the interface information of the warning target. Specifically, the network control unit 303 deletes the interface information of the warning target internally held in the RAM 203. Then, the process proceeds to S1104.

In S1103, the MFP 100 displays a warning message on the status line section 405 of the menu screen 400. As a display method, the network control unit 303 requests the display control unit 301 to display the warning message on the status line section 405. Then, the process proceeds to S1104.

In S1104, the MFP 100 closes each warning screen and displays the menu screen 400. As a display method, the network control unit 303 requests the display control unit 301 to close each warning screen and display the menu screen 400 on the operation unit 209. Then, this processing flow is ended. This allows the user to recognize that the MFP 100 is in a state where the warning is issued by referring to the status line section 405 when closing the warning screen without canceling the warning.

As described above, according to the present embodiment, it is possible to provide a function of recommending the user to disable the server functions in the serverless computing environment when connected to the serverless computing environment. Therefore, the user can recognize the necessity of disabling the server functions of the information device connected to the serverless computing environment, and can use the device with a reduced attack risk via the network.

In the present embodiment, the network control unit 303 can apply control of instructing the TCP/IP control unit 304 not to receive data from a line that is a warning target in the subsequent stage in S1005 of FIG. 10A. In this case, the control can be canceled at the subsequent stage in S1102 of FIG. 11. Due to this, the MFP 100 according to the present embodiment may be configured to block data reception of a line that is a warning target while an interface of a warning target exists. Doing this can reduce the risk of receiving an attack via the network in a state where the server functions are not disabled.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2024-000806, filed Jan. 5, 2024 which is hereby incorporated by reference herein in its entirety.

What is claimed is:

1. A server-configurable information processing apparatus, comprising:
one or more first memory devices that store a set of instructions; and
one or more first processors that execute the set of instructions to:
perform a setting whether server functions are enabled or disabled,
perform a setting whether or not to connect the information processing apparatus to a serverless computing environment, and
give notification prompting a user to change a setting so as to restrict use of the server functions in the serverless computing environment when the server functions are set to be enabled and the information processing apparatus is set to be connected to the serverless computing environment.

2. The information processing apparatus according to claim 1, wherein
giving the notification of prompting the user to change the setting so as to restrict use of the server functions includes displaying a warning screen including display prompting to change a setting so as to restrict use of the server functions.

3. The information processing apparatus according to claim 2, wherein
the warning screen further includes a first object, and
the one or more first processors that execute the set of instructions to:
block data reception to the information processing apparatus while the warning screen is displayed, and close the warning screen and cancel blocking of the data reception when the first object is operated.

4. The information processing apparatus according to claim 2, wherein
the warning screen further includes a second object, and
giving the notification of prompting the user to change the setting so as to restrict use of the server functions is closing the warning screen and performing display, on a status line, prompting to change a setting so as to restrict use of the server functions when the second object is operated.

5. The information processing apparatus according to claim 2, wherein
the warning screen further includes a third object for calling a setting to restrict use of the server functions.

6. The information processing apparatus according to claim 1, wherein
giving the notification prompting the user to change the setting so as to restrict use of the server functions is notification prompting to set to disable a setting of the server functions.

7. The information processing apparatus according to claim 1, wherein
giving the notification prompting the user to change the setting so as to restrict use of the server functions is giving notification prompting the user to perform a setting of a network filter.

8. The information processing apparatus according to claim 1, wherein
the one or more first processors that execute the set of instructions to:
perform a setting of a security policy,
wherein
giving the notification of prompting the user to change the setting so as to restrict use of the server functions is giving notification of recommending a review of the setting of the security policy.

9. The information processing apparatus according to claim 1, wherein
the one or more first processors that execute the set of instructions to:
give notification prompting the user to perform a setting of a network filter when the information processing apparatus is connected to a plurality of networks, the server functions are set to be enabled, and the information processing apparatus is set to be connected to the serverless computing environment.

10. The information processing apparatus according to claim 1, wherein
the one or more first processors that execute the set of instructions to:
give notification prompting the user to perform a setting of disabling the server functions when there is one line of the network to which the information processing apparatus is connected, the server functions are set to be enabled, and the information processing apparatus is set to be connected to the serverless computing environment.

11. The information processing apparatus according to claim 1, wherein
the one or more processors execute instructions in the one or more memory devices to:
set a security policy, and
give notification of a recommendation to review setting of the security policy when the server functions are set to be enabled, the information processing apparatus is set to be connected to the serverless computing environment, and the security policy is set.

12. The information processing apparatus according to claim 1, wherein
the one or more processors execute instructions in the one or more memory devices to:
perform a setting whether to give notification prompting the user to change a setting so as to disable the server functions in the serverless computing environment, and
give notification prompting the user to change a setting so as to restrict use of the server functions in the serverless computing environment when the server functions are set to be enabled, the information processing apparatus is set to be connected to the serverless computing environment, and a setting to give notification prompting the user is set.

13. A method for network setting of a server-configurable information processing apparatus, the method comprising:
performing a setting whether server functions are enabled or disabled,
performing a setting whether or not to connect the information processing apparatus to a serverless computing environment, and
giving notification prompting a user to change a setting so as to restrict use of the server functions in the serverless computing environment when the server functions are set to be enabled and the information processing apparatus is set to be connected to the serverless computing environment.

14. A non-transitory computer-readable storage medium, the storage medium storing a program for causing a computer to execute each step of a method for network setting of a server-configurable information processing apparatus, the method comprising:
performing a setting whether server functions are enabled or disabled,
performing a setting whether or not to connect the information processing apparatus to a serverless computing environment, and
giving notification prompting a user to change a setting so as to restrict use of the server functions in the serverless computing environment when the server functions are set to be enabled and the information processing apparatus is set to be connected to the serverless computing environment.
